(19) United States
(12) Patent Application Publication
(10) Pub. No.: US 2016/0118655 A1
(43) Pub. Date: Apr. 28, 2016

(54) NEGATIVE ELECTRODE ACTIVE MATERIAL AND NON-AQUEOUS ELECTROLYTE SECONDARY BATTERY, AND METHODS OF PRODUCING THE SAME

(71) Applicant: SHIN-ETSU CHEMICAL CO., LTD., Tokyo (JP)

(72) Inventors: Hiroki YOSHIKAWA, Takasaki (JP); Hiromichi KAMO, Takasaki (JP)

(21) Appl. No.: 14/890,367

(22) PCT Filed: May 1, 2014
(86) PCT No.: PCT/JP2014/002389

§ 371 Date: Nov. 10, 2015

(30) Foreign Application Priority Data
May 27, 2013 (JP) 2013-110775

(51) Int. Cl. H01M 4/38; H01M 10/0525; H01M 4/62

(52) U.S. Cl. CPC H01M 4/386; H01M 4/625; H01M 10/0525; H01M 2220/30

(57) ABSTRACT

A negative electrode active material for use in a non-aqueous electrolyte secondary battery. The negative electrode active material is composed of a mixture of a silicon-contained material and a carbon material and capable of being doped with lithium and de-doped. Silicon contained in the silicon-contained material has a crystallite size of 10 nm or less. This crystallite size is calculated by a Scherrer method from a half width of a diffraction peak attributable to Si (220) in X-ray diffraction. This negative electrode active material can maintain a high usage rate of the silicon-contained material at the time of charging and discharging in a non-aqueous electrolyte secondary battery that uses the mixture of the silicon-contained material and the carbon material as the negative electrode active material.

### TECHNICAL FIELD

The present invention relates to a negative electrode active material for use in a non-aqueous electrolyte secondary battery and the non-aqueous electrolyte secondary battery, and method of producing these.

### BACKGROUND ART

As mobile devices such as mobile electronic devices and mobile communication devices have highly developed, secondary batteries with higher energy density are recently needed to improve efficiency and reduce the size and weight of the devices. The capacity of the secondary batteries of this type can be improved by known methods: use of a negative electrode material made of an oxide of V, Si, B, Zr or Sn, or a complex oxide thereof (See Patent Documents 1 and 2, for example); use of a negative electrode material made of a metallic oxide subjected to melting and rapid cooling (See Patent Document 3, for example); use of a negative electrode material made of a silicon oxide (See Patent Document 4 for example); use of a negative electrode material made of Si₂N₂O and Ge₂N₂O (See Patent Document 5 for example), and others.

Although these conventional methods increase the charging and discharging capacities and energy density to some extent, the increase is insufficient for market needs and the cycle performance fails to fulfill the needs. The conventional methods need to further improve the energy density and thus are not entirely satisfactory. In particular, Patent Document 4 discloses use of a silicon oxide as a negative electrode material for a non-aqueous electrolyte secondary battery so as to obtain an electrode with a high capacity. This method, however, cannot achieve low irreversible capacity at the first charge and discharge and a practical level of cycle performance; thus, there is room for improvement in this method.

As disclosed in Patent Documents 6 and 7, improvements in first efficiency and cycle performance have been brought about. When a silicon oxide is used as a negative electrode active material, however, the first efficiency, which is the ratio of a discharging capacity to a first charging capacity, is about 70%. The combination of this material with a common positive electrode material that is currently used such as a lithium cobalt oxide makes it difficult to improve charging and discharging capacities per battery volume.

In view of this problem, a non-aqueous electrolyte secondary battery has been developed which uses a mixture of a carbon-based negative electrode active material that is conventionally used and a silicon oxide to improve the first efficiency and the charging and discharging capacities (See Patent Document 8, for example). However, use of the mixture of a carbon-based negative electrode active material and a silicon oxide arises the problem in that the expected improvement in the charging and discharging capacities cannot be achieved, because a contribution (a usage rate) of this silicon oxide to a charge and a discharge may be small.

### CITATION LIST

### Patent Literature

Patent Document 1: Japanese Unexamined Patent publication (Kokai) No. H05-174818

Patent Document 2: Japanese Unexamined Patent publication (Kokai) No. H06-60867

Patent Document 3: Japanese Unexamined Patent publication (Kokai) No. H10-294112

Patent Document 4: Japanese Patent No. 2997741

Patent Document 5: Japanese Unexamined Patent publication (Kokai) No. H11-102705

Patent Document 6: Japanese Patent No. 3952180

Patent Document 7: Japanese Patent No. 4081676

Patent Document 8: Japanese Unexamined Patent publication (Kokai) No. 2012-059721

### SUMMARY OF INVENTION

### Technical Problem

The present invention was accomplished in view of the above circumstances. It is an object of the present invention to provide a negative electrode active material that can maintain a high usage rate of a silicon-contained material at the time of charging and discharging in a non-aqueous electrolyte secondary battery that uses a mixture of the silicon-contained material and a carbon material as the negative electrode active material.

### Solution to Problem

To solve the problem, the present invention provides a negative electrode active material for use in a non-aqueous electrolyte secondary battery, comprising: a mixture of a silicon-contained material and a carbon material, wherein the negative electrode active material is capable of being doped with lithium and de-doped, and silicon contained in the silicon-contained material has a crystallite size of 10 nm or less, the crystallite size being calculated by a Scherrer method from a half width of a diffraction peak attributable to Si (220) in X-ray diffraction.

When the silicon contained in the silicon-contained material has a crystallite size of 10 nm or less, the formation of a region that fails to contribute to a charge and a discharge can be inhibited. The negative electrode active material composed of the mixture of the silicon-contained material and the carbon material can maintain a high usage rate of the silicon-contained material at the time of the charging and discharging, when used as the negative electrode active material of a non-aqueous electrolyte secondary battery.

The silicon-contained material of the inventive negative electrode active material is preferably configured such that silicon fine crystals or silicon fine particles are dispersed in a substance having a different composition from a composition of the silicon fine crystals or the silicon fine particles. In this case, the substance having the different composition from the composition of the silicon fine crystals or the silicon fine particles is preferably a silicon compound. The silicon compound is preferably silicon dioxide.

The negative electrode active material using these as the silicon-contained material can provide high charging and discharging capacities when used for a non-aqueous electrolyte secondary battery.

The silicon-contained material of the inventive negative electrode active material is preferably a silicon oxide represented by a general formula of SiOₓ (where 0.9≦x<1.6).

Use of a silicon oxide as the silicon-contained material allows a non-aqueous electrolyte secondary battery using the negative electrode active material to have high charging and discharging capacities.

The silicon-contained material is preferably coated with a conductive coating. In this case, the conductive coating is more preferably a coating containing carbon.

The silicon-contained material coated with a conductive coating, particularly a coating containing carbon, can achieve an improved structure to collect current.

The average particle size of the silicon-contained material of the inventive negative electrode active material is preferably equal to or less than 25 percent of an average particle size of the carbon material.

The silicon-contained material having an average particle size that is equal to or less than 25 percent of the average particle size of the carbon material can improve the charging and discharging capacities.

The content of the silicon-contained material of the inventive negative electrode active material in the mixture of the silicon-contained material and the carbon material is preferably 40 mass % or less.

When the content of the silicon-contained material is 40 mass % or less, the charging and discharging capacities per volume can be improved.

The invention also provides a non-aqueous electrolyte secondary battery comprising: a negative electrode containing any one of the negative electrode active materials; a positive electrode; and a non-aqueous electrolyte.

The non-aqueous electrolyte secondary battery having the negative electrode containing the inventive negative electrode active material can have an effectively improved battery capacity.

In this non-aqueous electrolyte secondary battery, the positive electrode preferably uses a positive electrode active material having a charging capacity of 190 mAh/g or more.

The positive electrode having a charging capacity of 190 mAh/g or more can improve the battery capacity when combined with the negative electrode containing the inventive negative electrode active material.

The invention also provides a method of producing a negative electrode active material composed of a mixture of a silicon-contained material and a carbon material, the negative electrode active material being capable of being doped with lithium and de-doped, comprising selectively using a material containing silicon having a crystallite size of 10 nm or less as the silicon-contained material, the crystallite size being calculated by a Scherrer method from a half width of a diffraction peak attributable to Si (220) in X-ray diffraction.

The producing method of a negative electrode active material using the mixture of the silicon-contained material selected in such a manner and the carbon material allows for production of a negative electrode active material that can maintain a high usage rate of the silicon-contained material at the time of the charging and discharging, when used as the negative electrode active material of a non-aqueous electrolyte secondary battery.

The invention also provides a method of producing a non-aqueous electrolyte secondary battery, comprising: making a negative electrode out of a negative electrode active material produced by this negative-electrode-active-material producing method; and producing the non-aqueous electrolyte secondary battery from the made negative electrode, a positive electrode, and a non-aqueous electrolyte.

This producing method can produce a non-aqueous electrolyte secondary battery having a high capacity by using the negative electrode active material containing the silicon-contained material selected in the above manner.

### Advantageous Effects of Invention

A negative electrode active material according to the invention can inhibit the formation of a region of a silicon-contained material that fails to contribute to a charge and a discharge in a non-aqueous electrolyte secondary battery using a mixture of a silicon-contained material and a carbon material as the negative electrode active material, thereby allowing the usage rate of the silicon-contained material to be kept high at the time of charging and discharging. A non-aqueous electrolyte secondary battery having a negative electrode containing this negative electrode active material can have an effectively improved battery capacity. Such a negative electrode active material and non-aqueous electrolyte secondary battery can be produced by the inventive method of producing a negative electrode active material and the inventive method of producing a non-aqueous electrolyte secondary battery.

### BRIEF DESCRIPTION OF DRAWINGS

FIG. 1 is a graph showing a porosity when a silicon-contained material is added to a carbon material;

FIG. 2 is a graph showing a discharging capacity per volume when a silicon-contained material is added to a carbon material;

FIG. 3 is a graph showing the relationship between a charging capacity of a positive electrode active material and a discharging capacity of the entire active material in a battery;

FIG. 4 is a graph showing a discharging capacity of the entire active material when the usage rate of a silicon-contained material is 63% and the first efficiency of the silicon-contained material is 69%;

FIG. 5 is a graph showing a discharging capacity of the entire active material when the usage rate of a silicon-contained material is 55% and the first efficiency of the silicon-contained material is 79%;

FIG. 6 is a graph showing a discharging capacity of the entire active material when the usage rate of a silicon-contained material is 18% and the first efficiency of the silicon-contained material is 66%; and

FIG. 7 is a graph showing the relationship between the crystallite size of silicon and the usage rate of a silicon-contained material in examples 1 and 2 and comparative example 1.

### DESCRIPTION OF EMBODIMENTS

It is very important to develop a material for an electrode having large charging and discharging capacities, as described above. The research to develop the material is carried out at various places. In such circumstances, a silicon-contained material such as silicon and a silicon oxide (SiOₓ) attract considerable attention as a negative electrode active material for use in a non-aqueous electrolyte secondary battery, because of its large capacity. A silicon oxide (SiOₓ) is particularly attractive because the silicon oxide is easier to form fine silicon particles in silicon dioxide than does metallic silicon powder and thereby facilitates improvements in various performances such as the cycle performance due to the fine silicon particles. However, use of the mixture of a carbon-based negative electrode active material and a silicon-contained material (particularly, a silicon oxide) arises the problem in that the expected improvement in the charging and discharging capacities cannot be achieved, because a contribution (a usage rate) of the silicon-contained material (particularly, a silicon oxide) to a charge and a discharge may be small, as described above.

The present inventors studied for an improvement in the usage rate of the silicon-contained material at the time of charging and discharging in a non-aqueous electrolyte secondary battery having a negative electrode using a negative electrode active material composed of a mixture of a silicon-contained material such as silicon and a silicon oxide (SiOₓ) and a carbon material. The inventors consequently found that if silicon contained in the silicon-contained material has a crystallite size of 10 nm or less that is calculated by a Scherrer method from a half width of a diffraction peak attributable to Si (220) in X-ray diffraction, then the usage rate of this silicon-contained material is improved, and the capacity of the non-aqueous electrolyte secondary battery can be effectively improved, thereby brought the invention to completion.

The present invention will be described below in more detail. It is to be noted that the symbol “%” described below represents mass % when the description is related to a mixture ratio.

The invention aims to improve the capacity of a non-aqueous electrolyte secondary battery using the negative electrode active material composed of the mixture of a silicon-contained material and a carbon material by improve the usage rate, which is a rate at which this silicon-contained material can contribute to a charge and a discharge.

A negative electrode active material for use in a non-aqueous electrolyte secondary battery according to the invention is made of the mixture of a silicon-contained material and a carbon material and capable of being doped with lithium and de-doped. Silicon contained in the silicon-contained material has a crystallite size of 10 nm or less that is calculated by a Scherrer method from a half width of a diffraction peak attributable to Si (220) in X-ray diffraction. The crystallite size is preferably in the range from 1 to 9 nm, more preferably in the range from 1 to 8 nm. More specifically, the crystallite size of the silicon can be calculated from a spread of a diffraction line attributable to Si (220) centered near 2θ=47.5° in X-ray diffraction (Cu-Kα) using copper as an anticathode.

The inventive negative electrode active material can be produced by making a silicon-contained material containing silicon with a crystallite size of 10 nm or less and using this silicon-contained material. Alternatively, it may be checked whether the produced negative electrode active material has silicon with a crystallite size of 10 nm or less. The inventive negative electrode active material can also be produced by selectively using a material containing silicon having a crystallite size of 10 nm or less that is calculated by a Scherrer method from a half width of a diffraction peak attributable to Si (220) in X-ray diffraction, as the silicon-contained material.

If the silicon is perfectly amorphous and formed as a harmonious whole, then because of its high reactivity, there is a risk that gives rise to variation in performance during preservation and makes it difficult to prepare a slurry when an electrode is produced. If the crystallite size of the silicon is more than 10 nm, then there is a risk that reduces the usage rate because of a region that fails to contribute to a charge and a discharge, created in some silicon particles. The silicon-contained material used in the inventive negative electrode active material, in contrast, contains silicon with a crystallite size of 10 nm or less, thereby enabling the inhibition of the formation of a region that fails to contribute to a charge and a discharge. Accordingly, a negative electrode active material composed of the mixture of this silicon-contained material and a carbon material can maintain a high usage rate of the silicon-contained material at the time of charging and discharging when used as the negative electrode active material of a non-aqueous electrolyte secondary battery.

The silicon-contained material used in the invention preferably has the following properties in addition to the crystallite size of silicon.

The silicon-contained material is preferably configured such that silicon fine crystals or silicon fine particles are dispersed in a substance having a different composition from a composition of the silicon fine crystals or the silicon fine particles, so that the charging and discharging capacities are improved when this material is used for a non-aqueous electrolyte secondary battery. The substance having the different composition from the composition of the silicon fine crystals or the silicon fine particles is preferably a silicon compound, particularly silicon dioxide.

The silicon-contained material is preferably coated with a conductive coating. The coating made of a conductive substance on the surface of particles of the silicon-contained material can achieve an improved structure to collect current. This coating prevents the creation of a particle that fails to contribute a charge and a discharge and allows a non-aqueous electrolyte secondary battery having a high usage rate at the initial stage of repetition of charging and discharging to be obtained. Examples of the conductive substance include metal and carbon. In particular, the coating made of the conductive substance preferably contains carbon. Although a common method of coating with the conductive substance is physical vapor deposition (PVD) or chemical vapor deposition (CVD), it is also acceptable to use electroplating or a method of forming carbon by carbonization of an organic substance.

If a silicon oxide is mainly used as the raw material of the silicon-contained material, then the amount of dispersed silicon fine particles in a material of silicon dioxide and silicon dispersed therein is preferably in the range from 2 to 36 mass %, more preferably in the range from 10 to 30 mass %. When the amount of dispersed silicon is 2 mass % or more, the charging and discharging capacities can be sufficiently increased; when this amount is 36 mass % or less, sufficient cycle performance can be maintained.

If metallic silicon is used as the raw material of the silicon-contained material, then the amount of dispersed silicon fine particles in the composite is preferably in the range from 10 to 95 mass %, more particularly in the range from 20 to 90 mass %. When this dispersion amount is 10 mass % or more, an advantage of the metallic silicon raw material can be exploited; when this amount is 95 mass % or less, the status of the dispersed silicon particles can be readily maintained, and the usage rate can be improved.

The average particle size of the silicon-contained material is preferably 0.01 μm or more. This average particle size is more preferably 0.1 μm or more, further preferably 0.2 μm or more, particularly preferably 0.3 μm or more. The upper limit of the average particle size of the silicon-contained material is preferably 8 μm or less, more preferably 5 μm or less, further preferably 3 μm or less. If the average particle size is too small, then a bulk density becomes small, and the charging and discharging capacities per unit volume are decreased. The above range however can avoid such a harmful effect. If the average particle size is too large, then when this material is used by being mixed with a carbon material, an improvement in the density of this mixture may be inhibited, and an improvement in the charging and discharging capacities in terms of the total volume may be inhibited. The above range however can avoid such a harmful effect. It is to be noted that this average particle size of the silicon-contained material is a value measured as a mass mean particle size D₅₀ (i.e., a particle size when a cumulative mass is 50% or a median particle size) in measurement of particle size distribution by a laser diffraction scattering.

The BET specific surface area of powder of the silicon-contained material used in the invention is preferably 0.1 m²/g or more, more preferably 0.2 m²/g or more. The upper limit of this BET specific surface area is preferably 30 m²/g or less, more preferably 20 m²/g or less. When the BET specific surface area is 0.1 m²/g or more, its surface activity can be sufficiently made large and the binding strength of a binder when an electrode is produced can be increased. This enables the cycle performance to be prevented from decreasing when a charge and a discharge are repeated. When the BET specific surface area is 30 m²/g or less, the amount of a solvent to be absorbed when an electrode is produced is prevented from becoming too large, and no large amount of binder is needed to maintain the binding strength. This enables the cycle performance and the conductivity to be prevented from decreasing. It is to be noted that these BET specific surface areas are values measured by a single point BET method using the amount of an N₂ gas to be absorbed.

A method of producing a negative electrode active material according to the invention will now be described. A method of making powder of a silicon-contained material in the invention is not particularly limited, provided the crystallite size of silicon contained is 10 nm or less. The following method, for example, can be preferably used.

A method of performing a heat treatment on a silicon oxide represented by a general formula of SiOₓ (where 0.9≦x<1.6) at temperatures of 1,100° C. or less under an inert gas atmosphere or a reducing atmosphere will be described. The term “silicon oxide” in the invention is a general term for an amorphous silicon oxide obtained by heating a mixture of silicon dioxide and metallic silicon to produce a silicon monoxide gas and cooling the silicon monoxide gas and depositing a solid. Silicon oxide powder that can be used in the invention is represented by a general formula of SiOₓ. The average particle size of this silicon oxide powder is preferably 0.01 μm or more. This average particle size is more preferably 0.1 μm or more, further preferably 0.2 μm or more, particularly preferably 0.3 μm or more. The upper limit of the average particle size of the silicon oxide powder is preferably 8 μm or less, more preferably 5 μm or less, further preferably 3 μm or less. The BET specific surface area of the silicon oxide powder is preferably 0.1 m²/g or more, more preferably 0.2 m²/g or more. The upper limit of this BET specific surface area is preferably 30 m²/g or less, more preferably 20 m²/g or less. The range of x is preferably 0.9≦x<1.6, more preferably 0.9≦x≦1.3, further preferably 1.0≦x≦1.2. When the average particle size and BET specific surface area of the silicon oxide powder are within the above range, powder of a silicon-contained material having a desired average particle size and BET specific surface area can be obtained. When the value of x is 0.9 or more, SiOₓ powder can be readily made. When the value of x is less than 1.6, the ratio of inactive SiO₂ that may be created when a heat treatment is performed can be reduced to a low level, and the charging and discharging capacities can be inhibited from decreasing when this material is used for a non-aqueous electrolyte secondary battery.

It is to be noted that the temperature of a plate used to cool the silicon monoxide gas produced by heating the mixture of silicon dioxide and metallic silicon and to deposit a solid is preferably controlled to be 1,050° C. or less. When a part of this plate has a temperature of 1,050° C. or less, variations in the crystallite size of silicon can be limited to within a prescribed range under control of the following heat treatment conditions, and a desired silicon-contained material can more reliably be obtained.

The heat treatment on the silicon oxide is performed at 1,100° C. or less. If the temperature of this heat treatment is more than 1,100° C., then the usage rate may be reduced because the crystallite size of silicon is increased to more than 10 nm. The heat treatment temperature is preferably 1,050° C. or less, more preferably 1,000° C. or less. It is to be noted that when the silicon oxide is obtained by cooling the silicon monoxide gas, which is produced by heating the mixture of silicon dioxide and metallic silicon, and depositing a solid, the temperature of the plate often becomes 500° C. or more. In other words, the silicon oxide is often obtained substantially by performing a heat treatment at temperatures of 500° C. or more. The substantial lower limit of the heat treatment temperature can accordingly be regarded as being 500° C.

The time for this heat treatment on the silicon oxide can be adjusted properly within the range from 10 minutes to 20 hours, particularly within the range from 30 minutes to 12 hours, depending on the heat treatment temperature; for example, when the heat treatment temperature is 1,100° C., about 5 hours is preferable.

This heat treatment on the silicon oxide is not particularly limited, provided a reactor having a heater is used under an insert gas atmosphere. This heat treatment can be performed continuously or in a batch manner. More specifically, a fluidized bed reactor, a rotary furnace, a vertical moving bed reactor, a tunnel furnace, a batch furnace, a rotary kiln, and so on may be selected properly depending on the purpose. In this heat treatment, a gas that is inert at the above heat treatment temperature, such as Ar, He, H2, or N₂, can be used singly or as a mixed gas.

Alternatively, silicon fine particles can be obtained by using metallic silicon as a raw material. For example, the silicon fine particles can be obtained by heating and evaporating metallic silicon in a vacuum and rapidly cooling the resultant for re-deposition on a cooled plate. Silicon dioxide or alumina is added to this silicon fine particles and the resultant is strongly pulverized and mixed, so that the silicon-contained material configured such that silicon fine crystals or silicon fine particles are dispersed in a substance having a different composition from a composition of the silicon fine crystals or the silicon fine particles can be produced.

A method of making powder of the silicon-contained material that is obtained by the above exemplary method and coated with a coating made of a conductive substance (a conductive coating) will be described. This silicon-contained material is also referred to as a “conductive silicon-contained material” below. In this method, a heat treatment to form the coating made of a conductive substance can function as the above heat treatment on the silicon oxide powder if the raw material to be used is silicon oxide powder. In this manner, the production cost can be reduced.

The method of making powder of the conductive silicon-contained material (the silicon-contained material coated with the coating made of a conductive substance) is not particularly limited, provided this powder is obtained by coating particles of the silicon-contained material containing silicon having a crystallite size of 10 nm or less with a conductive substance such as carbon. The following methods I to IV, for example, can be preferably used.

### [Method I]

Silicon oxide powder represented by a general formula of SiOₓ (where 0.9≦x<1.6) or silicon composite powder is used as a raw material. This silicon composite powder is obtained by adding silicon dioxide, alumina or the like to metallic silicon powder composed of silicon fine crystals or particles and strongly pulverizing and mixing the resultant. By such a method, this silicon composite powder is configured such that the silicon fine crystals or particles are dispersed in a substance having a different composition from a composition of the silicon fine crystals or particles. This raw material is subjected to a heat treatment at temperatures ranging from 600 to 1,100° C., preferably from 700 to 1,050° C., more preferably from 700 to 1,000° C., further preferably from 700 to 950° C., under an atmosphere containing at least an organic gas and/or vapor. This heat treatment causes the silicon oxide powder of the raw material to disproportionate to a composite of silicon and silicon dioxide and vapor-deposits carbon on its surface.

### [Method II]

Silicon oxide powder represented by a general formula of SiOₓ (where 0.9≦x<1.6) or silicon composite powder is used as a raw material. This silicon composite powder is obtained by adding silicon dioxide, alumina or the like to metallic silicon powder composed of silicon fine crystals or particles and strongly pulverizing and mixing the resultant. By such a method, this silicon composite powder is configured such that the silicon fine crystals or particles are dispersed in a substance having a different composition from a composition of the silicon fine crystals or particles. This silicon oxide powder or this silicon composite powder is previously heated at temperatures ranging from 600 to 1,100° C. under an inert gas stream. This raw material is subjected to a heat treatment at temperatures ranging from 600 to 1,100° C., preferably from 700 to 1,050° C., more preferably from 700 to 1,000° C., under an atmosphere containing at least an organic gas and/or vapor. This heat treatment vapor-deposits carbon on its surface.

### [Method III]

Silicon oxide powder represented by a general formula of SiOₓ (where 0.9≦x<1.6) or silicon composite powder is used as a raw material. This silicon composite powder is obtained by adding silicon dioxide, alumina or the like to metallic silicon powder composed of silicon fine crystals or particles and strongly pulverizing and mixing the resultant. By such a method, this silicon composite powder is configured such that the silicon fine crystals or particles are dispersed in a substance having a different composition from a composition of the silicon fine crystals or particles. This raw material is subjected to a heat treatment at temperatures ranging from 500 to 1,100° C., preferably from 500 to 1,050° C., more preferably from 500 to 900° C., under an atmosphere containing at least an organic gas and/or vapor. This heat treatment vapor-deposits carbon on its surface. The particles on which carbon has been vapor-deposited are subjected to a heat treatment at temperatures ranging from 600 to 1,100° C., preferably from 700 to 1,050° C., more preferably from 700 to 1,000° C., under an inert gas atmosphere.

### [Method IV]

Silicon oxide powder represented by a general formula of SiOₓ (where 0.9≦x<1.6) or silicon composite powder obtained by adding silicon dioxide, alumina or the like to metallic silicon powder composed of silicon fine crystals or particles and strongly pulverizing and mixing the resultant is prepared. By such a method, this silicon composite powder is configured such that the silicon fine crystals or particles are dispersed in a substance having a different composition from a composition of the silicon fine crystals or particles. This silicon oxide powder or this silicon composite powder is mixed with a carbon source such as sucrose. The resultant is then subjected to carbonization at temperatures ranging from 500 to 1,100° C., preferably from 500 to 1,050° C., more preferably from 500 to 900° C., and used as a raw material. This raw material is subjected to a heat treatment at temperatures ranging from 600 to 1,100° C., preferably from 800 to 1,050° C., more preferably from 800 to 1,000° C., under an inert gas atmosphere.

In the above method I or II, if the vapor deposition of carbon (i.e., thermal CVD), which may be performed at temperatures ranging from 600 to 1,100° C. (preferably from 700 to 1,050° C., more preferably from 700 to 1,000° C.), is performed by a heat treatment at 600° C. or more, then the conductive carbon coating and the silicon-contained material can be well combined and the carbon atoms can be well aligned (crystallized). When this heat treatment is performed at 1,100° C. or less, the usage rate can be inhibited from decreasing due to excessive growth of the silicon fine particles.

In the above methods I to IV, the heat treatment on the powder of the silicon-contained material allows silicon to have a controlled crystallite size, so it can be expected that a prescribed quality is maintained. In this case, when the heat treatment is performed at 600° C. or more, the crystallite size of the silicon can be readily controlled, and variations in battery characteristics of this negative electrode material can be reduced to a low level. When the heat treatment is performed at 1,100° C. or less, the usage rate can be inhibited from decreasing due to excessive growth of the silicon fine particles.

In the above method III or IV, since the heat treatment on the powder of the silicon-contained material is performed at temperatures ranging from 600 to 1,100° C., particularly from 800 to 1,000° C. after the carbon coating process, the silicon composite and the conductive carbon coating in which the carbon atoms are aligned (crystallized) can be finally combined on the surface even when the carbon coating process is performed at temperatures of less than 600° C.

In this way, the thermal CVD (chemical vapor deposition at 600° C. or more) and carbonization are preferably performed to form the carbon film. The time for these processes is determined properly according to the relation with the amount of carbon. These processes may cause the particles to aggregate. In this case, these aggregating particles are pulverized, for example, with a ball mill. Alternatively, the thermal CVD is repeated in the same manner depending on the circumstances.

In the method I, it is necessary to properly determine the temperature of the chemical vapor deposition and the heat treatment, the processing time, the type of raw material to generate the organic gas, and the concentration of an organic gas. The time for the heat treatment is normally selected from the range from 0.5 to 12 hours, preferably from 1 to 8 hours, particularly from 2 to 6 hours. This heat treatment time is also related to the heat treatment temperature; for example, when the heat treatment temperature is 1000° C., the heat treatment is preferably performed for at least 5 hours or more.

In the method II, the heat treatment time (the time for the CVD) is normally selected from the range from 0.5 to 12 hours, particularly from 1 to 6 hours if this heat treatment is performed under an atmosphere containing an organic gas and/or vapor. It is to be noted that the time for the heat treatment previously performed on the silicon oxide of SiOₓ can be normally 0.5 to 6 hours, particularly 0.5 to 3 hours.

In the method III, the time (the time for the CVD) for the heat treatment previously performed on the powder of the silicon-contained material under an atmosphere containing an organic gas and/or vapor can be normally 0.5 to 12 hours, particularly 1 to 6 hours. The time for the heat treatment under an inert gas atmosphere can be normally 0.5 to 6 hours, particularly 0.5 to 3 hours.

In the method IV, the time for the carbonization previously performed on the powder of the silicon-contained material can be normally 0.5 to 12 hours, particularly 1 to 6 hours. The time for the heat treatment under an inert gas atmosphere can be normally 0.5 to 6 hours, particularly 0.5 to 3 hours.

The organic material used as the raw material to generate an organic gas in the invention is selected from materials capable of producing carbon (graphite) by pyrolysis at the above heat treatment temperature particularly under a non-oxidizing atmosphere.

Examples of such organic materials include aliphatic or alicyclic hydrocarbon, such as methane, ethane, ethylene, acetylene, propane, butane, butene, pentane, isobutane, hexane, and a mixture thereof, and monocyclic to tricyclic aromatic hydrocarbons, such as benzene, toluene, xylene, styrene, ethylbenzene, diphenylmethane, naphthalene, phenol, cresol, nitrobenzene, chlorobenzene, indene, cumarone, pyridine, anthracene, phenanthrene, and a mixture thereof. In addition to these, gas light oils, creosote oils, anthracene oils, naphtha-cracked tar oils that are produced in the tar distillation process can be used alone or as a mixture. The carbon source used for the carbonization can be various organic substances: carbohydrate such as sucrose, various kinds of hydrocarbon such as acrylonitrile and pitch, or derivatives thereof, as well known examples.

All the thermal CVD (the thermal chemical vapor deposition), the heat treatment, and the carbonization are not particularly limited, provided a reactor having a heater is used under a non-oxidizing atmosphere. These processes can be performed, for example, continuously or in a batch manner. More specifically, a fluidized bed reactor, a rotary furnace, a vertical moving bed reactor, a tunnel furnace, a batch furnace, a rotary kiln, and so on may be selected properly depending on the purpose. A gas used in this heat treatment can be the above organic gas or a mixed gas of the organic gas and a non-oxidizing gas such as Ar, He, H2, or N₂.

In this case, a reactor having a rotatable furnace tube that is horizontally provided, such as the rotary furnace and rotary kiln. Use of this reactor to perform the chemical vapor deposition while moving the silicon oxide particles enables stable production without causing these silicon oxide particles to aggregate. The rotational speed of the furnace tube is preferably 0.5 to 30 rpm, particularly 1 to 10 rpm. It is to be noted that this reactor is not particularly limited, provided the reactor has the furnace tube capable of maintaining the atmosphere, a rotating mechanism to rotate the furnace tube, and a heater to increase and maintain the temperature. Depending on the purpose, the reactor may be provided with a mechanism to supply a raw material (e.g., a feeder), a mechanism to collect goods (e.g., a hopper), or the furnace tube may be inclined or provided with a baffle plate to control the residence time of the raw material. The material of the furnace tube is not particularly limited, and may be selected properly from the group of ceramic such as silicon carbide, alumina, mullite, and silicon nitride, a metal having a high melting point such as molybdenum and tungsten, stainless steel (SUS), and quartz, depending on the conditions or purpose of the processes.

When the linear velocity u (m/sec) of fluidizing gas is within the range satisfying 1.5≦u/u_{mf}≦5, where u_{mf} is the velocity at the beginning of the fluidization, the conductive coating can be more efficiently formed. When u/u_{mf} is 1.5 or more, the fluidization is satisfactory, resulting in the formation of a uniform conductive coating. When u/u_{mf} is 5 or less, secondary aggregation of particles is inhibited from occurring, resulting in the formation of a uniform conductive coating. It is to be noted that the velocity at the beginning of the fluidization varies depending on the size of particles, a processing temperature, a processing atmosphere, and so on. This velocity at the beginning of the fluidization can be defined as the value of the linear velocity of fluidizing gas when powder pressure loss becomes W/A where W is the weight of powder and A is the cross sectional area of a fluidization layer as the fluidizing gas is gradually increased, i.e., the linear velocity of the flowing gas is gradually increased. It is to be noted that u_{mf} can be normally 0.1 to 30 cm/sec, preferably 0.5 to 10 cm/sec. The particle diameter that provides these values of u_{mf} is normally 0.5 to 100 μm, preferably 5 to 50 μm. When the particle diameter is 0.5 μm or more, the occurrence of the secondary aggregation can be inhibited, and the surface of each particle can be effectively treated, so this particle diameter is preferable.

Use of powder of the obtained silicon-contained material or conductive silicon-contained material doped with lithium allows the produced negative electrode to inhibit the degradation of the first capacity efficiency and the capacity at the initial charging and discharging cycle (i.e., decreasing rate of the initial capacity).

One exemplary method is to mix the powder of the silicon-contained material or conductive silicon-contained material with lithium hydride, lithium aluminum hydride, or lithium alloy and then heat the resultant. Another exemplary method is to add the silicon composite powder or powder of the conductive silicon-contained material and lithium alloy into a solvent, mix the resultant, and then pre-dope this mixture with lithium by performing a heat treatment to form lithium silicate.

When the powder of the silicon-contained material or conductive silicon-contained material and lithium alloy are added into a solvent and the resultant is mixed, the solvent can be selected from the group consisting of carbonates, lactones, sulfolanes, ethers, hydrocarbons, and a mixture thereof that do not react with lithium metal and a lithium-doped material. Use of such a solvent can more effectively prevent electrical storage devices such as batteries or capacitors produced with the produced negative electrode material doped with lithium from being affected by the decomposition when the devices are charged or discharged.

The solvent can be configured such that the solvent does not react with lithium metal and a lithium-doped material and has a boiling point of 65° C. or more. The solvent having a boiling point of 65° C. or more can more effectively prevent the difficulty in uniformly mixing lithium metal due to the evaporation of the solvent when mixed.

A thin-film spin high speed kneader can be used for the above mixing process. The thin-film spin high speed kneader can also be used after the process of mixing the material with the solvent in which lithium metal having a thickness of 0.1 mm or more has been added. In this manner, use of the thin-film spin high speed kneader enables an efficient mixing process. In view of the rate of lithium pre-doping and the productivity, lithium metal having a thickness of 0.1 mm or more is preferably used.

The heat treatment to dope with lithium can be performed at temperatures ranging from 200 to 1,100° C. This temperature is preferably 200° C. or more to efficiently undergo a chemical change from active lithium to stable lithium silicate. When this temperature is 1,100° C. or less, the usage rate can be prevented from decreasing due to the growth of silicon crystals.

The invention can increase the capacity more readily and efficiently by using a mixture of the above obtained the powder of the silicon-contained material or conductive silicon-contained material and a carbon material as the negative electrode active material, compared with a conventional non-aqueous electrolyte secondary battery that uses a negative electrode active material mainly composed of a carbon material. A method of using a mixture of the silicon-contained material or conductive silicon-contained material and a carbon material will now be described.

When the mixture of the silicon-contained material or conductive silicon-contained material and a carbon material is used, the average particle size of the silicon-contained material is preferably smaller than the average particle size of the carbon material for the following reason.

For a negative electrode active material mainly composed of a carbon material, a comparatively soft material such as graphite is normally used as this carbon material. In this case, the negative electrode active material is applied to a metal foil that is to function as a current collector and dried. This metal foil is then pressed with a press or another means to increase its bulk density. In this way, the charging and discharging capacities in terms of the total battery volume are improved. At this time, if the applied material (the negative electrode mixture) is excessively pressed, it is difficult for an electrolyte to spread through the negative electrode mixture, resulting in reduction in battery performance. Accordingly, its porosity is often determined to be 0.2 to 0.3. If the mixture of a silicon-contained material and a carbon material can be applied and pressed without greatly changing these conditions, then the capacity of a battery can be increased without greatly changing a production process.

In view of this, the porosity of the negative electrode mixture was considered on the premise that the silicon-contained material is mixed with the same carbon material as a conventional battery mainly using the carbon material. This porosity is shown in FIG. 1. FIG. 1 is a graph showing the porosity when the silicon-contained material is added to the carbon material. It is to be noted that the average particle size of the carbon material was 20 μm, the porosity was 25 volume %, and the porosity of the silicon-contained material was 40 volume %. In FIG. 1, curved lines designated as “silicon 3 μm”, “silicon 5 μm”, and “silicon 7 μm” correspond to silicon-contained materials having an average particle size of 3 μm, 5 and 7 μm, respectively. The same is true for the other figures.

It can be understood from FIG. 1 that there is a minimal value of the porosity when the average particle size of the silicon-contained material is 5 μm or less (See the curved line of the silicon 3 μm and 5 μm), and the silicon-contained material is efficiently arranged in gaps in the carbon material. Under this circumstance, it can be expected that the charging and discharging capacities are improved due to an improvement in the density of the negative electrode mixture, and the expansion of the negative electrode mixture itself when the silicon-contained material is expanded at the time of charging can be relieved because the silicon-contained material is expanded in the gaps in the carbon material. For the above reason, the average particle size of the silicon-contained material is preferably 5 μm or less when the average particle size of the carbon material is 20 μm. The average particle size of the silicon-contained material is preferably equal to or less than five twentieth of the average particle size of the carbon material. In other words, the ratio of both the average particle sizes is preferably 25% or less.

The charging and discharging capacities for the mixture of the silicon-contained material and the carbon material was then estimated by using the same conditions (particle size and porosity) as above. To estimate the battery capacity, these capacities were represented by the discharging capacity per volume in total of the negative electrode mixture and positive electrode mixture. The preconditions of this estimation was determined as follows.

### Positive Electrode Mixture

The density of an active material in the positive electrode mixture was 3.0 g/cm³.

The first charging capacity of the positive electrode active material was 200 mAh/g.

The first capacity efficiency of the positive electrode active material was 100%.

### Negative Electrode Mixture

The first charging capacity of the silicon-contained material was 2,200 mAh/g.

The first capacity efficiency of the silicon-contained material was 65%.

The porosity of the silicon-contained material was 0.4.

The first charging capacity of the carbon material was 380 mAh/g.

The first capacity efficiency of the carbon material was 90%.

The density of an active material of the carbon material was 1.7 g/cm³.

The average particle size of the carbon material was 20 μm.

The porosity of the carbon material was 0.25.

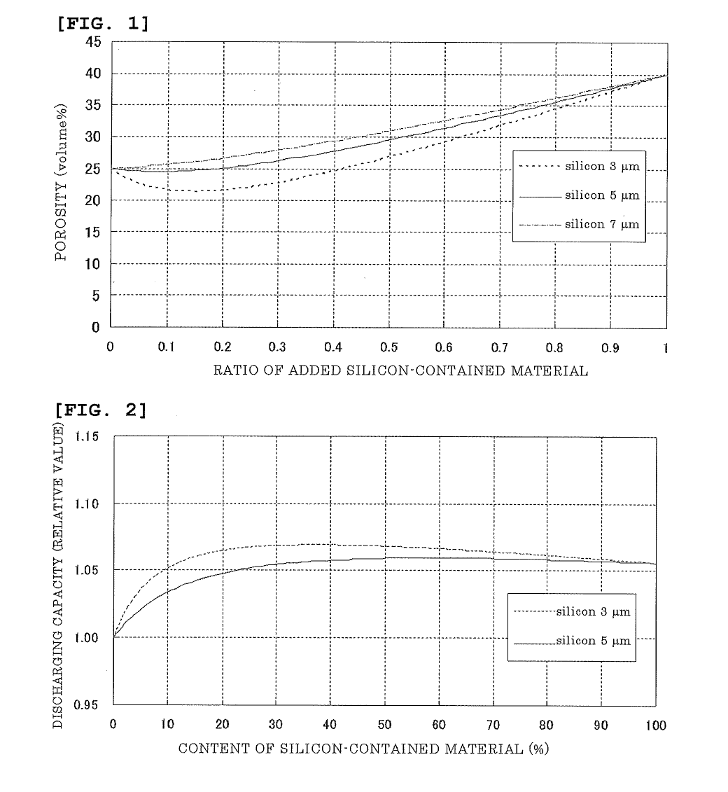

FIG. 2 is a graph showing the discharging capacity per volume for the mixture of the silicon-contained material and the carbon material. It can be understood from FIG. 2 that although the discharge capacity increased as the amount of added silicon-contained material increased when the mass ratio of added silicon-contained material to the carbon material was 40% (mass %) or less, the discharge capacity hardly increased when this ratio was more than 40%. This result indicates that the ratio of the silicon-contained material to be added, i.e., the content of the silicon-contained material in the mixture of the silicon-contained material and the carbon material, is preferably 40 mass % or less. When the ratio is 40 mass % or less, an advantage of increasing the battery capacity is gained, and the effect of the expansion of the silicon-contained material can be reduced during charging. In order to increase the discharging capacity by adding the silicon-contained material, the amount of the added silicon-contained material is more preferably 20 mass % or less, particularly preferably 10 mass % or less. In particular, when this amount is 10 mass % or less, the gaps created among the particles of the carbon material are efficiently filled with the particles of the silicon-contained material, and the effect of the expansion of the silicon-contained material during charging can be reduced, so the battery capacity can be improved by modifying the prior art.

A non-aqueous electrolyte secondary battery according to the invention includes a negative electrode containing the above obtained negative electrode active material, a positive electrode, and a non-aqueous electrolyte. The inventive non-aqueous electrolyte secondary battery is characterized by using the silicon-contained material or conductive silicon-contained material and the carbon material as the negative electrode active materials. Except for the negative electrode containing the negative electrode active material of this type, other conditions such as the material of a positive electrode, an electrolyte, and a separator, and the shape of a battery are not limited. Examples of the positive electrode active material include a transition metal oxide and a chalcogen compound such as LiCoO₂, LiNiO₂, LiMn₂O₄, V₂O₅, MnO₂, TiS₂, and MoS₂. An exemplary electrolyte is a non-aqueous solution containing a lithium salt such as lithium perchlorate. Examples of the non-aqueous solvent include propylene carbonate, ethylene carbonate, dimethoxyethane, γ-butyrolactone, 2-methyltetrahydrofuran, and a mixture thereof. In addition to these solutions, various solid electrolytes and other non-aqueous electrolytes may be used.

For the negative electrode using the silicon-contained material as an active material, however, because the first efficiency (the first charging capacity/the first discharging capacity) of the silicon-contained material is lower than the first efficiency of the carbon material, a positive electrode active material to compensate a decrease in the first efficiency is preferably used. In consideration of the compensation of the first efficiency, a positive electrode active material having larger charging and discharging capacities can reduce its amount needed for the compensation, thereby increasing the battery capacity. FIG. 3 shows the relationship between the charging capacity of the positive electrode active material and the discharging capacity of the entire active material in a battery (i.e., the discharging capacity in terms of the total mass of the positive electrode mixture and the negative electrode mixture). The discharge capacity plotted on the vertical axis shows relative values converted such that the discharging capacity of a graphite negative electrode active material is 1. It is clear from FIG. 3 that a positive electrode active material having a charging capacity of 190 mAh/g or more provides a discharging capacity of 1 or more, and accordingly improves the battery capacity by the combination with the silicon-contained material.

The graph in FIG. 3 shows the result of the case of using the following materials.

The first charging capacity of the silicon-contained material was 2,200 mAh/g.

The first capacity efficiency of the silicon-contained material was 65%.

The first charging capacity of the carbon material was 380 mAh/g.

The first capacity efficiency of the carbon material was 90%.

When a negative electrode is produced by using the silicon-contained material or conductive silicon-contained material, a conductive agent such as carbon powder or carbon nanofiber can be added in addition to the silicon-contained material and the carbon material such as graphite. In this case, the type of the conductive agent is not particularly limited, provided the conductive agent is a material having electron conductivity that neither decomposes nor transmutes in a battery produced with this material. Specific examples of the conductive agent include powder or fiber of metal such as Al, Ti, Fe, Ni, Cu, Zn, Ag, Sn, and Si, and graphite such as natural graphite, synthetic graphite, various types of coke powder, mesophase carbon, vapor-grown carbon fiber, pitch-based carbon fiber, polyacrylonitrile (PAN) based carbon fiber, and various types of sintered resin.

The amount of conductive agent to be added is preferably 1 to 30%, more preferably 2 to 20%, particularly preferably 2 to 10%, with respect to the mixture of the silicon-contained material powder or conductive silicon-contained material powder, the carbon material, and a conductive agent. When the amount of the conductive agent is 1% or more, it is unlikely to block a conductive path due to the expansion or contraction at charging and discharging, and the effect of the conductive agent can more reliably be achieved. When the amount of the conductive agent is 30% or less, the reduction in the battery capacity can be inhibited.

### EXAMPLE

The present invention will be specifically described below with reference to examples and a comparative example, but the invention is not limited to these examples. It is to be noted that the symbol “6” described below represents mass % when the description is related to a mixture ratio.

### Example 1

A silicon oxide represented by a general formula of SiOₓ (where 0.9≦x<1.6) was used as the silicon-contained material. This material was obtained in such a manner that a mixture of silicon dioxide and metallic silicon was heated to generate a silicon monoxide gas, this silicon monoxide gas was cooled to deposit a solid while the temperature of a plate for the deposition was adjusted to 900° C., and then a heat treatment was performed at 1000° C. under a vacuum for 3 hours. This silicon oxide had an average particle size of 5 μm and a silicon crystallite size of 3.36 nm; this crystallite size was calculated by a Scherrer method from a half width of a diffraction peak attributable to Si (220) centered near 2θ=47.5° with an X-ray diffraction pattern using Cu-Kα ray. In addition, graphite powder having an average particle size of 20 μm was prepared as the carbon material. The used positive electrode active material was composed of lithium, nickel, cobalt, and manganese composite oxide (Mole ratio: Li=1, Ni=0.7, Co=0.2, Mn=0.1).

### [Production of Electrodes]

### (Negative Electrode Made of the Carbon Material)

The following negative electrode of the carbon material was produced as a reference negative electrode for comparison. A slurry was formed by mixing 100 parts of the carbon material, 1.5 parts of sodium carboxymethylcellulose (CMC-Na), 1.5 parts of styrene-butadiene rubber (SBR), and pure water (60° C.) as a dispersing agent. This slurry was applied to a copper foil having a thickness of 15 μm. This sheet after the application was pre-dried at 85° C. for 30 minutes, and dried at 130° C. for 5 hours in a vacuum. This dried sheet was pressed with a roller press, and finally die-cut into a 2-cm² negative electrode of the carbon material. The density of the mixture of the obtained sheet was 1.7 g/cm³.

### (Negative Electrode Made of the Silicon-Contained Material)

A negative electrode of the silicon-contained material was produced as a reference negative electrode for comparison by the following processes. A slurry was formed by mixing 100 parts of the silicon-contained material (silicon oxide), 7 parts of acetylene black, 6 parts of carbon nanotube, 20 parts of polyimide, and N-methylpyrrolidone as a dispersion agent. This slurry was applied to a copper foil having a thickness of 15 μm. This sheet after the application was pre-dried at 85° C. for 30 minutes in a vacuum. This dried sheet was pressed with a roller press. The pressed sheet was dried at 400° C. for 2 hours in a vacuum. The dried sheet was finally die-cut into a 2-cm² negative electrode of the silicon-contained material. The density of the mixture of the obtained sheet was 0.85 g/cm³.

### (Negative Electrode of a Mixture of Carbon and Silicon)

The inventive negative electrode active material was produced by mixing 5 parts of the silicon-contained material (silicon oxide) and 95 parts of the carbon material. A negative electrode was produced by using this negative electrode active material as follows. A slurry was formed by mixing 100 parts of this negative electrode active material, 1.5 parts of CMC-Na, 1.5 parts of SBR, and pure water (60° C.) as a dispersion agent. This slurry was applied to a copper foil having a thickness of 15 μm. This sheet after the application was pre-dried at 85° C. for 30 minutes, and dried at 130° C. for 5 hours in a vacuum. The dried sheet was pressed with a roller press, and finally die-cut into a 2-cm² negative electrode of the mixture of carbon and silicon. The density of the mixture of the obtained sheet was 1.7 g/cm³.

### (Positive Electrode)

A positive electrode was produced by using a positive electrode active material of lithium, nickel, cobalt, and manganese composite oxide at a mole ratio of Li:Ni:Co:Mn=1:0.7:0.2:0.1 under the following conditions. A slurry was formed by mixing 95 parts of the above positive electrode active material, 1.5 parts of acetylene black, 1 part of carbon nanotube, 2.5 parts of polyvinylidene fluoride, and N-methylpyrrolidone as a dispersion agent. This slurry was applied to an aluminum foil having a thickness of 15 μm. This sheet after the application was pre-dried at 85° C. for 10 minutes in the air. This dried sheet was pressed with a roller press. The pressed sheet was dried at 130° C. for 5 hours in a vacuum. The dried sheet was finally die-cut into a 2-cm² positive electrode. The density of the obtained positive electrode mixture was 3.0 g/cm³.

To evaluate the charging and discharging capacities of the obtained negative electrodes (the negative electrode of the carbon material and the negative electrode of the silicon-contained material) and the positive electrode, a half-cell for evaluation was fabricated by using a metallic lithium counter electrode, a non-aqueous electrolyte solution obtained by dissolving lithium hexafluorophosphate in a 1/1 (a volume ratio) mixture of ethylene carbonate and 1,2-dimethoxyethane at a concentration of 1 mole/liter, a separator made of a polyethylene microporous film having a thickness of 30 μm.

After the fabricated half-cell was left at room temperature a night, its battery capacity was measured under the following charge and discharge conditions by using a secondary battery charging and discharging tester (made by NAGANO K.K).

### (Negative Electrode Made of the Silicon-Contained Material and Negative Electrode Made of the Carbon Material)

The half-cell to evaluate the negative electrode was charged with a constant current of 1.5 mA (0.75 mA/cm²) until the voltage of the cell reached 5 mV. After this voltage reached 5 mV, the charging was continued while the current was decreased such that the voltage of the cell kept 5 mV. When the current was decreased to less than 0.2 mA (0.1 mA/cm²), the charging was terminated to measure the charging capacity. The half-cell was then discharged with a constant current of 0.6 mA (0.3 mA/cm²). When the voltage of the cell was increased to more than 2,000 mV, the discharging was terminated to measure the discharging capacity. It is to be noted that the charging and discharging capacities were converted to a discharging capacity per gram of the negative electrode active material. The charging and discharging capacities of the electrodes will be described below.

For the negative electrode of the carbon material, the charging capacity was 380 mAh/g, and discharging capacity was 358 mAh/g.

For the negative electrode of the silicon-contained material, the charging capacity was 2658 mAh/g, and the discharging capacity was 2020 mAh/g.

### (Positive Electrode)

The half-cell to evaluate the positive electrode was charged with a constant current of 1.5 mA (0.75 mA/cm²) until the voltage of the cell reached 4,200 mV. After this voltage reached 4,200 mV, the charging was continued while the current was decreased such that the voltage of the cell kept 4,200 mV. When the current was decreased to less than 0.2 mA, the charging was terminated to measure the charging capacity. The half-cell was then discharged with a constant current of 0.6 mA (0.3 mA/cm²). When the voltage of the cell was decreased to less than 3,000 mV, the discharging was terminated to measure the discharging capacity. The charging and discharging capacities of the positive electrode will be described below.

For the positive electrode, the discharge capacity was 193 mAh/g.

Non-aqueous electrolyte secondary batteries were then fabricated by using the above obtained negative electrodes (the negative electrode of the carbon material and the negative electrode of the mixture of carbon and silicon), a positive electrode, a non-aqueous electrolyte solution obtained by dissolving lithium hexafluorophosphate in a 1/1 (a volume ratio) mixture of ethylene carbonate and 1,2-dimethoxyethane at a concentration of 1 mole/liter, a separator made of a polyethylene microporous film having a thickness of 30 μm.

Each of the fabricated non-aqueous electrolyte secondary batteries was left at room temperature a night. With a secondary battery charging and discharging tester (made by NAGANO K.K), the battery was charged with a constant current of 2.5 mA until the voltage of the battery reached 4.2 V. After this voltage reached 4.2 V, the charging was continued while the current was decreased such that the voltage of the battery kept 4.2 V. When the current was decreased to less than 0.5 mA (0.25 mA/cm²), the charging was terminated to measure the charging capacity. The battery was then discharged with a constant current of 2.5 mA (1.25 mA/cm²). When the voltage of the battery was decreased to less than 2.75 V, the discharging was terminated to measure the discharging capacity. It is to be noted that the discharging capacity was converted to a discharging capacity per gram of the negative electrode active material of the silicon-contained material and the carbon material.

From the above results, a usage rate at which the silicon-contained material in the negative electrode of the mixture of carbon and silicon contributed to the discharge was calculated by the following expressions. Let ‘A’ (mAh/g) denote the discharge capacity improved by adding the silicon-contained material contained in the negative electrode of the mixture of carbon and silicon. A is defined as:

A=b3−b2×α2

Let ‘B’ (%) denote the usage rate at which the silicon-contained material in the negative electrode of the mixture of carbon and silicon contributed to the discharge. B is defined as:

B=100×A/(α1×b1)

Let ‘C’ (%) denote the first efficiency at which the silicon-contained material in the negative electrode of the mixture of carbon and silicon contributed to the charge and the discharge. C is defined as:

C=100×(b3−b2×α2)/(α3−α2×α2)

Let ‘D’ (%) denote the ratio of the improved discharging capacity of the negative electrode of the mixture of carbon and silicon to the discharging capacity of the negative electrode of the carbon material. D is defined as:

D=100×b3/b2

### (Description of the Variables in the Expressions)

The variables used in the above expressions carry the following meanings.

### Electrode Composition

The content of the silicon-contained material in the negative electrode of the mixture of carbon and silicon, i.e., the content in the negative electrode active material, is denoted by α1.

The content of the carbon material in the negative electrode of the mixture of carbon and silicon, i.e., the content in the negative electrode active material, is denoted by α2.

### Capacity of the Half-Cell for Evaluation

The first charging capacity of the positive electrode is denoted by α1 (mAh/g).

The first discharging capacity of the negative electrode of the silicon-contained material is denoted by b1 (mAh/g).

### Capacity of the Non-Aqueous Electrolyte Secondary Battery

The first charging capacity of the negative electrode of the carbon material is denoted by α2 (mAh/g).

The first charging capacity of the negative electrode of the mixture of carbon and silicon is denoted by α3 (mAh/g).

The first discharging capacity of the negative electrode of the carbon material is denoted by b2 (mAh/g).

The first discharging capacity of the negative electrode of the mixture of carbon and silicon is denoted by b3 (mAh/g).

The charging capacity (the first charging capacity α1) of the non-aqueous electrolyte secondary battery using the negative electrode of the carbon material was 380 (mAh/g); its discharging capacity (the first discharging capacity b2) was 358 (mAh/g). These values were used to calculate the usage rate B at which the silicon-contained material in the negative electrode of the mixture of carbon and silicon contributed to the discharge, and the first efficiency C at which the silicon-contained material in the negative electrode of the mixture of carbon and silicon contributed to the discharge. In addition, the ratio D of the improved discharging capacity of the negative electrode of the mixture of carbon and silicon to the discharging capacity of the negative electrode of the carbon material was calculated. The result is shown in Table 1 below.

TABLE 1

| | average | | | | | | |
|---|---|---|---|---|---|---|---|
| | particle size | | | | | | |
| | of silicon- | crystallite | | | | | |
| | contained | size of | | discharge | | | |
| | material | silicon | | capacity | B | C | D |
| No. | (μm) | (nm) | α1 | (mAh/g) | (%) | (%) | (%) |
| 1 | 5 | 3.36 | 0.05 | 404 | 63 | 69 | 113 |

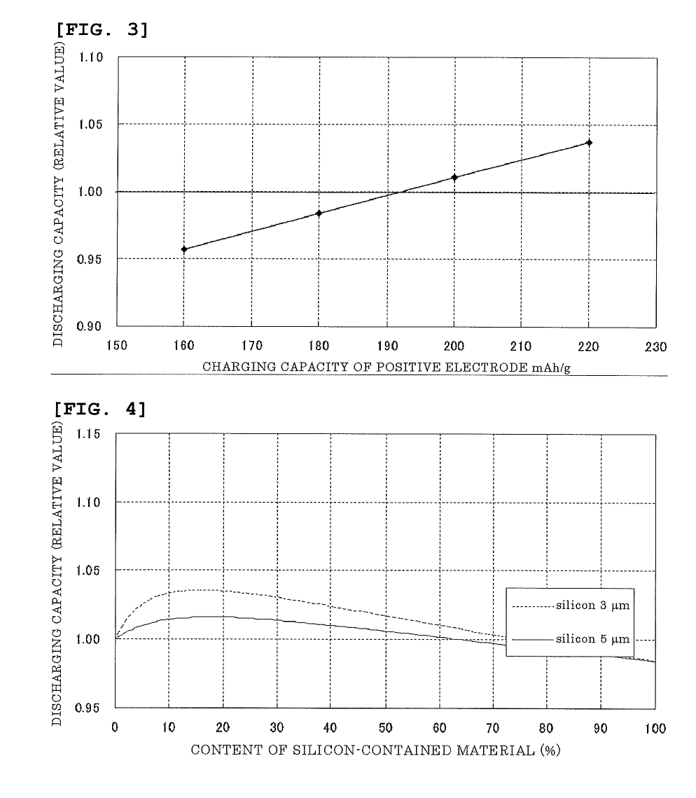

FIG. 4 shows the estimated battery capacity (the discharge capacity in terms of the whole active materials) when the usage rate of the silicon-contained material was 63%, and the first efficiency was 69% (corresponding to No. 1). In this case, the particle size was 20 μm and the carbon material contracted until its porosity became 0.25. The horizontal axis in FIG. 4 shows the content of the silicon-contained material in the active material of the mixture of carbon and silicon. The vertical axis in FIG. 4 shows the discharge capacity by a relative value calculated by using the discharge capacity of the negative electrode of the carbon material (i.e., containing no silicon-contained material) as a reference.

As shown in FIG. 4, it was confirmed that the battery in example 1 improved its capacity in terms of the whole active materials of the positive and negative electrodes, when the content of the silicon-contained material is 10% or less.

### Example 2

A conductive silicon-contained material obtained by coating a silicon oxide represented by a general formula of SiOₓ (where 0.9≦x<1.6) with carbon was used as the silicon-contained material. This material was obtained by the following processes. A mixture of silicon dioxide and metallic silicon was heated to generate a silicon monoxide gas. This silicon monoxide gas was cooled to deposit a solid while the temperature of a plate for the deposition was adjusted to 900° C. This deposit was pulverized to form silicon oxide powder having an average particle size of 5 μm. This powder was subjected to a thermal CVD to form a carbon film thereon by leaving the powder in temperatures of 600° C. to 1,100° C. for 3 to 10 hours while a mixed gas of methane and argon was introduced at a flow rate of 2 NL/min, so that the target material was obtained.

This silicon oxide had an average particle size of 5 μm and a silicon crystallite size ranging from 3.17 to 8.78 nm; this crystallite size was calculated by a Scherrer method from a half width of a diffraction peak attributable to Si (220) centered near 2θ=47.5° with an X-ray diffraction pattern using Cu-Kα ray. In addition, the same carbon material and positive electrode active material as example 1 were used.

### [Battery Evaluation]

A negative electrode of the silicon-contained material and a negative electrode of the mixture of carbon and silicon were produced under the same conditions as example 1 by using the above conductive silicon-contained material to evaluate batteries in the same manner as example 1. The usage rate B and the first efficiency C of the silicon-contained material in the negative electrode of the mixture of carbon and silicon were calculated. The improved discharging capacity ratio D was also calculated. These results are shown in Table 2.

TABLE 2

| | average | | | | | | |
|---|---|---|---|---|---|---|---|
| | particle size | | | | | | |
| | of silicon- | crystallite | | | | | |
| | contained | size of | | discharge | | | |
| | material | silicon | | capacity | B | C | D |
| No. | (μm) | (nm) | α1 | (mAh/g) | (%) | (%) | (%) |
| 2 | 5 | 3.17 | 0.05 | 410 | 77 | 74 | 115 |
| 3 | 5 | 3.29 | 0.05 | 410 | 77 | 76 | 115 |
| 4 | 5 | 4.87 | 0.05 | 397 | 64 | 78 | 111 |
| 5 | 5 | 4.77 | 0.05 | 396 | 63 | 75 | 111 |
| 6 | 5 | 8.78 | 0.05 | 382 | 55 | 79 | 107 |

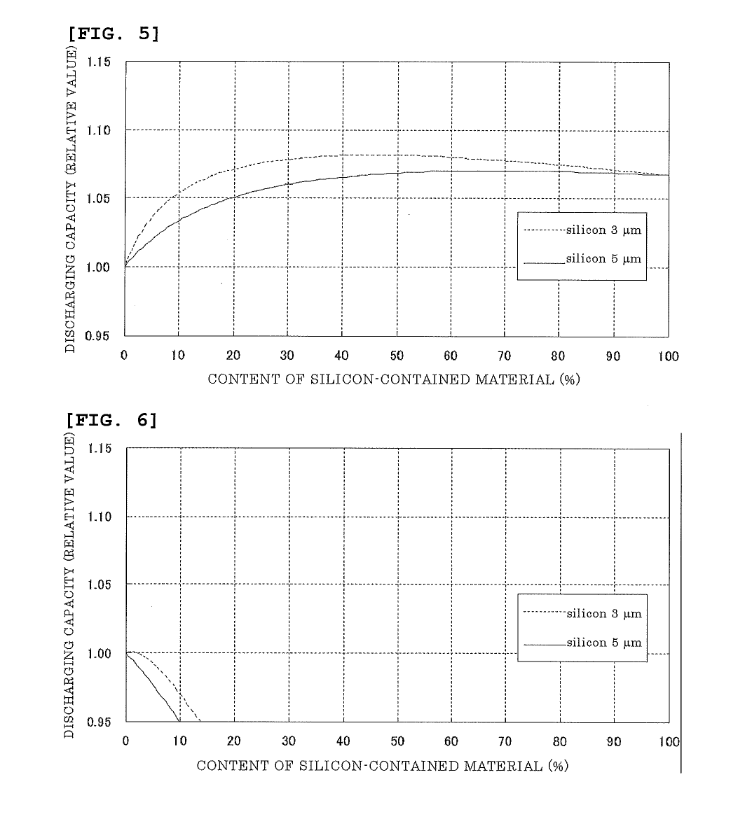

FIG. 5 shows the result of estimated battery capacity (the discharge capacity in terms of the whole active materials) of the battery in No. 6 having the lowest usage rate among No. 2 to No. 6 in which the usage rate of the silicon-contained material was 55% and its first efficiency was 79%. The horizontal axis in FIG. 5 shows the content of the silicon-contained material in the active material of the mixture of carbon and silicon. The vertical axis in FIG. 5 shows the discharge capacity by a relative value calculated by using the discharge capacity of the negative electrode of the carbon material (i.e., containing no silicon-contained material) as a reference.

It was confirmed from the result shown in FIG. 5 that the battery capacity in terms of the whole active materials of the positive and negative electrodes was improved, when the content of the silicon-contained material is 30% or less.

### Comparative Example 1

A conductive silicon-contained material obtained by coating a silicon oxide represented by a general formula of SiOₓ (where 0.9≦x<1.6) with carbon was used as the silicon-contained material. This material was obtained by the following processes. A mixture of silicon dioxide and metallic silicon was heated to generate a silicon monoxide gas. This silicon monoxide gas was cooled to deposit a solid while the temperature of a plate for the deposition was adjusted to 1,100° C. This deposit was pulverized to form silicon oxide powder having an average particle size of 5 This powder was subjected to a thermal CVD to form a carbon film thereon by leaving the powder in temperatures of 1,200° C. to 1,300° C. for 3 to 10 hours while a mixed gas of methane and argon was introduced at a flow rate of 2 NL/min, so that the target material was obtained.

This silicon oxide had an average particle size of 5 μm and a silicon crystallite size ranging from 10.63 to 13.02 nm; this crystallite size was calculated by a Scherrer method from a half width of a diffraction peak attributable to Si (220) centered near 2θ=47.5° with an X-ray diffraction pattern using Cu-Kα ray. In addition, the same carbon material and positive electrode active material as example 1 were used.

### [Battery Evaluation]

A negative electrode of the silicon-contained material and a negative electrode of the mixture of carbon and silicon were produced under the same conditions as example 1 by using the above conductive silicon-contained material to evaluate batteries in the same manner as example 1. The usage rate B and the first efficiency C of the silicon-contained material in the negative electrode of the mixture of carbon and silicon were calculated. The improved discharging capacity ratio D was also calculated. These results are shown in Table 3.

TABLE 3

| | average | | | | | | |
|---|---|---|---|---|---|---|---|
| | particle size | | | | | | |
| | of silicon- | crystallite | | | | | |
| | contained | size of | | discharge | | | |
| | material | silicon | | capacity | B | C | D |
| No. | (μm) | (nm) | α1 | (mAh/g) | (%) | (%) | (%) |
| 7 | 5 | 10.63 | 0.05 | 353 | 18 | 66 | 99 |
| 8 | 5 | 13.02 | 0.05 | 352 | 17 | 70 | 99 |

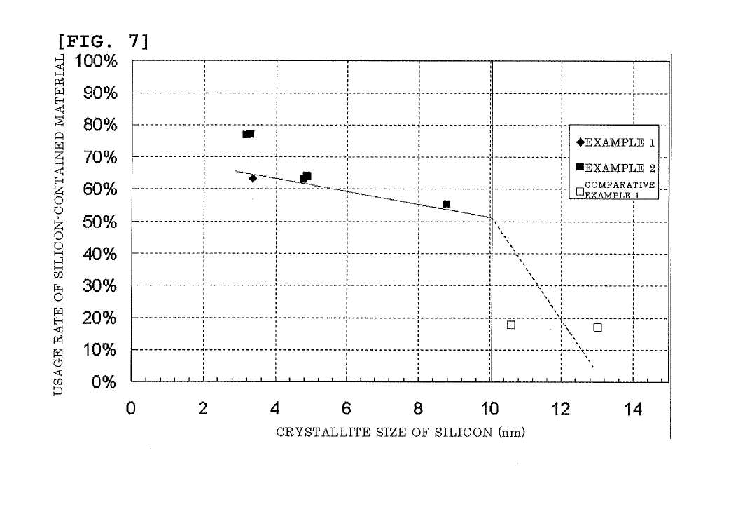

FIG. 6 shows the result of estimated battery capacity (the discharge capacity in terms of the whole active materials) of the battery in No. 7 having a higher usage rate between No. 7 and No. 8 in which the usage rate of the silicon-contained material was 18% and its first efficiency was 66%. The horizontal axis in FIG. 6 shows the content of the silicon-contained material in the active material of the mixture of carbon and silicon. The vertical axis in FIG. 6 shows the discharge capacity by a relative value calculated by using the discharge capacity of the negative electrode of the carbon material (i.e., containing no silicon-contained material) as a reference.

It was confirmed from the result shown in FIG. 6 that the battery capacity in terms of the whole active materials of the positive and negative electrodes was decreased regardless of the content of the silicon-contained material.

### [Verification of Effect by the Drawings]

Since the usage rate of a silicon-contained material greatly affects the battery capacity, use of a silicon-contained material having a high usage rate is important to improve the battery capacity by using a negative electrode of a mixture of carbon and silicon. The results of examples 1 and 2 and comparative example 1 are shown together in FIG. 7. FIG. 7 shows the relationship between the crystallite size of silicon and the usage rate B of the silicon-contained material. As clearly seen in FIG. 7, it was confirmed that the usage rate B depends on the crystallite size of silicon in the silicon-contained material and this material has clearly a good area when the crystallite size is 10 nm or less. It was also seen that example 2 in which carbon was coated exhibited a better result than example 1.

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

1-13. (canceled)

14. A negative electrode active material for use in a non-aqueous electrolyte secondary battery, comprising:
a mixture of a silicon-contained material and a carbon material, wherein
the negative electrode active material is capable of being doped with lithium and de-doped, and
silicon contained in the silicon-contained material has a crystallite size of 10 nm or less, the crystallite size being calculated by a Scherrer method from a half width of a diffraction peak attributable to Si (220) in X-ray diffraction.

15. The negative electrode active material according to claim 14, wherein the silicon-contained material is configured such that silicon fine crystals or silicon fine particles are dispersed in a substance having a different composition from a composition of the silicon fine crystals or the silicon fine particles.

16. The negative electrode active material according to claim 15, wherein the substance having the different composition from the composition of the silicon fine crystals or the silicon fine particles is a silicon compound.

17. The negative electrode active material according to claim 16, wherein the silicon compound is silicon dioxide.

18. The negative electrode active material according to claim 14, wherein the silicon-contained material is a silicon oxide represented by a general formula of SiOₓ (where 0.9≦x<1.6).

19. The negative electrode active material according to claim 15, wherein the silicon-contained material is a silicon oxide represented by a general formula of SiOₓ (where 0.9≦x<1.6).

20. The negative electrode active material according to claim 16, wherein the silicon-contained material is a silicon oxide represented by a general formula of SiOₓ (where 0.9≦x<1.6).

21. The negative electrode active material according to claim 17, wherein the silicon-contained material is a silicon oxide represented by a general formula of SiOₓ (where 0.9≦x<1.6).

22. The negative electrode active material according to claim 14, wherein the silicon-contained material is coated with a conductive coating.

23. The negative electrode active material according to claim 22, wherein the conductive coating is a coating containing carbon.

24. The negative electrode active material according to claim 14, wherein an average particle size of the silicon-contained material is equal to or less than 25 percent of an average particle size of the carbon material.

25. The negative electrode active material according to claim 14, wherein a content of the silicon-contained material in the mixture of the silicon-contained material and the carbon material is 40 mass % or less.

26. A non-aqueous electrolyte secondary battery comprising:
a negative electrode containing a negative electrode active material according to claim 14;
a positive electrode; and
a non-aqueous electrolyte.

27. The non-aqueous electrolyte secondary battery according to claim 26, wherein the positive electrode uses a positive electrode active material having a charging capacity of 190 mAh/g or more.

28. A method of producing a negative electrode active material composed of a mixture of a silicon-contained material and a carbon material, the negative electrode active material being capable of being doped with lithium and de-doped, comprising
selectively using a material containing silicon having a crystallite size of 10 nm or less as the silicon-contained material, the crystallite size being calculated by a Scherrer method from a half width of a diffraction peak attributable to Si (220) in X-ray diffraction.

29. A method of producing a non-aqueous electrolyte secondary battery, comprising:
making a negative electrode out of a negative electrode active material produced by the method according to claim 28; and
producing the non-aqueous electrolyte secondary battery from the made negative electrode, a positive electrode, and a non-aqueous electrolyte.
